(19) United States
(12) Patent Application Publication
(10) Pub. No.: US 2016/0070289 A1
(43) Pub. Date: Mar. 10, 2016

(54) VOLTAGE GENERATING CIRCUIT

(71) Applicant: KABUSHIKI KAISHA TOSHIBA, Tokyo (JP)

(72) Inventor: Tetsuya FUJITA, Kawasaki Kanagawa (JP)

(21) Appl. No.: 14/634,872

(22) Filed: Mar. 1, 2015

(30) Foreign Application Priority Data
Sep. 10, 2014 (JP) 2014-184530

(51) Int. Cl. G05F 3/24

(52) U.S. Cl. CPC G05F 3/24

(57) ABSTRACT

A voltage generating circuit includes a voltage control circuit that includes an output section and a reference voltage terminal to which a reference voltage is supplied, and outputs a voltage to the output section which is controlled so as to be equal to a voltage of the reference voltage terminal, a first voltage dividing MOS transistor having a first end connected to the output section, and a second voltage dividing MOS transistor having a first end connected to a second end of the first voltage dividing MOS transistor. The voltage generating circuit further includes an auxiliary circuit having a set terminal to which an enable signal is supplied. In response to the enable signal, the auxiliary circuit outputs a first target voltage to the first end of the first voltage dividing MOS transistor and outputs a second target voltage to the first end of the second voltage dividing MOS transistor.

### CROSS-REFERENCE TO RELATED APPLICATION

This application is based upon and claims the benefit of priority from Japanese Patent Application No. 2014-184530, filed Sep. 10, 2014, the entire contents of which are incorporated herein by reference.

### FIELD

Embodiments described herein relate generally to a voltage generating circuit.

### BACKGROUND

In a voltage generating circuit of the related art, polysilicon resistors are mainly used in a voltage dividing unit that divides a voltage. When a high resistance value is required for the purpose of lowering current consumption, a polysilicon resistor requires a large element area as the resistance value increases, and in the polysilicon resistor, reduction of current consumption is not practical due to space restrictions.

There exists, however, a voltage dividing circuit which employs a thin gate oxide MOSFET (Metal Oxide Semiconductor Field Effect Transistor) instead of a high resistance element. In such a thin gate oxide MOSFET, a gate area decreases as the resistance value increases. However, there is a concern that if the gate area decreases too much, the gate leakage current decreases, and it takes too much time to converge when a voltage is divided by the thin gate oxide MOSFET. That is, a time required for converging an output voltage based on the divided voltage becomes longer.

### DESCRIPTION OF THE DRAWINGS

FIG. 1 is a diagram illustrating an example of a configuration of a voltage generating circuit according to a first embodiment.

FIG. 2 is a diagram illustrating an example of a configuration of a voltage generating circuit according to a second embodiment.

FIG. 3 is a diagram illustrating an example of a configuration of a voltage generating circuit according to a third embodiment.

### DETAILED DESCRIPTION

Example embodiments provide a voltage generating circuit in which it is possible to reduce a circuit area, reduce current consumption, and reduce a convergence time of the output voltage.

In general, according to one embodiment, a voltage generating circuit includes a voltage control circuit that includes an output section and a reference voltage terminal to which a reference voltage is supplied, and outputs a voltage to the output section, the output voltage being controlled so as to be equal to a voltage of the reference voltage terminal, and at least two voltage dividing MOS transistors connected in series including a first voltage dividing MOS transistor having a first end connected to the output section and a second voltage dividing MOS transistor having a first end connected to a second end of the first voltage dividing MOS transistor. The voltage generating circuit further includes an auxiliary circuit that includes a set terminal to which an enable signal is supplied. In response to the enable signal, the auxiliary circuit outputs a first target voltage to the first end of the first voltage dividing MOS transistor and outputs a second target voltage to the first end of the second voltage dividing MOS transistor. The voltage generating circuit further includes an output circuit having an output terminal and being configured to output the output voltage to the output terminal, based on a voltage that is obtained by dividing the voltage of the output section using the first and second voltage dividing MOS transistors.

The first voltage dividing MOS transistor is a pMOS transistor having a source, a drain, and a back gate that are connected to the output section of the voltage control circuit and having a gate connected to the one end of the second voltage dividing MOS transistor, and the second voltage dividing MOS transistor is a pMOS transistor having a source, a drain, and a back gate that are connected to the other end of the first voltage dividing MOS transistor and having a gate connected to the ground.

Alternatively, the first voltage dividing MOS transistor is an nMOS transistor having a source, a drain, and a back gate that are connected to the one end of the second voltage dividing MOS transistor and having a gate connected to the output section of the voltage control circuit, and the second voltage dividing MOS transistor is an nMOS transistor having a source, a drain, and a back gate that are connected to the ground and having a gate connected to the other end of the first voltage dividing MOS transistor.

Hereinafter, each embodiment is described based on the drawings.

### First Embodiment

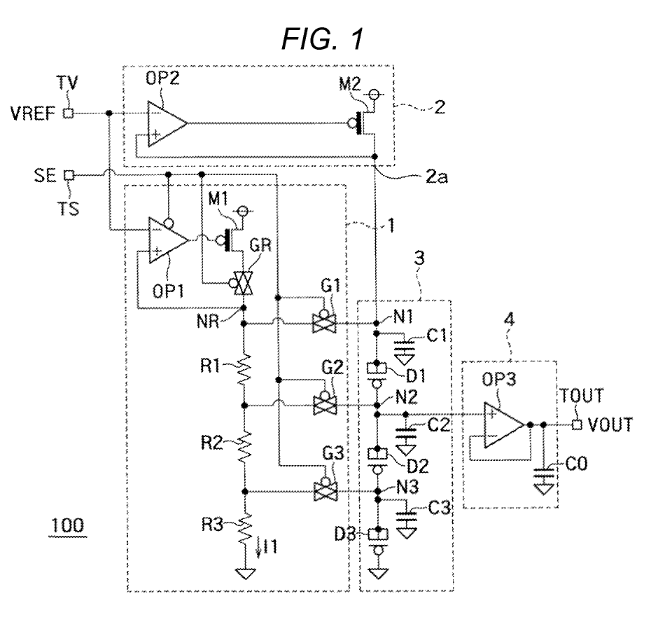

FIG. 1 is a diagram illustrating an example of a configuration of a voltage generating circuit 100 according to a first embodiment.

As illustrated in FIG. 1, the voltage generating circuit 100 includes a reference voltage terminal TV, a set terminal TS, an output terminal TOUT, an auxiliary circuit 1, a voltage control circuit 2, a voltage dividing circuit 3, and an output circuit 4.

A reference voltage VREF is supplied to the reference voltage terminal TV. The reference voltage VREF is provided from an external portion of the voltage generating circuit 100. Then, the reference voltage VREF is set to a voltage equal to or lower than a power supply voltage.

An enable signal SE is supplied to the set terminal TS.

The output voltage VOUT is output from the output terminal TOUT.

The auxiliary circuit 1 outputs a first target voltage to a first node N1, in response to the enable signal SE, outputs a second target voltage to a second node N2, and outputs a third target voltage to a third node N3.

In addition, the first target voltage is set to a voltage that is equal to a voltage of the first node N1 when the output voltage VOUT is in a normal state. The second target voltage is set to a voltage that is equal to a voltage of the second node N2 when the output voltage VOUT is in a normal state. Lastly, the third target voltage is set to a voltage that is equal to a voltage of the third node N3 when the output voltage VOUT is in a normal state.

Here, as illustrated in FIG. 1, for example, the auxiliary circuit 1 includes a first resistance element R1, second resistance element R2, a third resistance element R3, a first control MOS transistor M1, a first transmission gate (switching element) G1, a second transmission gate G2, a third transmission gate G3, a current supply blocking transmission gate GR, and a first operational amplifier OP1.

The first control MOS transistor M1 has one end (source) connected to a power supply. The first control MOS transistor M1 is a pMOS transistor in the example in FIG. 1, but may be an nMOS transistor.

The transmission gate GR has one end connected to the other end (drain) of the first control MOS transistor M1, and has the other end connected to a node NR.

The transmission gate GR turns on when the enable signal SE is a low level, whereby the one end is electrically connected to the other end. Meanwhile, the transmission gate GR turns off when the enable signal SE is a high level, whereby the one end is electrically disconnected from the other end.

The first resistance element R1 has one end connected to the node NR.

The second resistance element R2 has one end connected to the other end of the first resistance element R1, and the other end (via the third resistance element R3) connected to ground.

In addition, the third resistance element R3 is connected between the other end of the second resistance element R2 and the ground.

In addition, for example, the first to third resistance elements R1 to R3 have relatively small (about several hundred kΩ) resistance values (that is, a circuit area is relatively small). The first to third resistance elements R1 to R3 are configured with, for example, polysilicon resistors.

The first operational amplifier OP1 has an inverting input terminal connected to the reference voltage terminal TV, and a non-inverting input terminal connected to the node NR.

The first operational amplifier OP1 turns on to operate when the enable signal SE is a low level, and is disabled when the enable signal SE is a high level. When the first operational amplifier OP1 operates, a gate voltage of the first control MOS transistor M1 is controlled in such a manner that the reference voltage VREF is equal to a voltage of the node NR.

As a result, the reference voltage VREF and the voltage of the node NR are controlled so as to be equal to each other.

In addition, the voltage control circuit 2 includes an output section 2a, and outputs a voltage that is controlled so as to be equal to a voltage of the reference voltage terminal TV to the output section 2a.

As illustrated in FIG. 1, the voltage control circuit 2 includes a second control MOS transistor M2 and a second operational amplifier OP2.

The second control MOS transistor M2 has one end (source) connected to the power supply, and the other end (drain), which is the output section 2a, connected to the first node N1. The second control MOS transistor M2 is a pMOS transistor in the example of FIG. 1, but may be an nMOS transistor.

The voltage dividing circuit 3 is connected between the output section 2a and the ground.

As illustrated in FIG. 1, for example, the voltage dividing circuit 3 includes a first voltage dividing MOS transistor D1, a second voltage dividing MOS transistor D2, a third voltage dividing MOS transistor D3, a first capacitor C1, a second capacitor C2, and a third capacitor C3.

The first to third voltage dividing MOS transistors D1 to D3 are connected in series between the first node N1 and the ground, in such a manner that a gate insulating film leakage current flows.

The first voltage dividing MOS transistor D1 is connected between the first node N1 and the second node N2.

In the example of FIG. 1, the first voltage dividing MOS transistor D1 has a source, a drain, and a back gate that are connected to the first node N1 (output section 2a of the voltage control circuit 2), and is a pMOS transistor having a gate connected to the second node N2.

In addition, the second voltage dividing MOS transistor D2 is connected between the second node N2 and the ground (particularly, between the second node N2 and the third node N3, in the example of FIG. 1).

In the example of FIG. 1, the second voltage dividing MOS transistor D2 has a source, a drain, and a back gate that are connected to the second node N2 and is a pMOS transistor having a gate connected to the third node N3.

The third voltage dividing MOS transistor D3 is connected between the third node N3 that is connected to the gate of the second voltage dividing MOS transistor D2 and ground.

In the example of FIG. 1, the third voltage dividing MOS transistor D3 has a source, a drain, and a back gate that are connected to the third node N3 and is a pMOS transistor having a gate connected to the ground.

The first to third voltage dividing MOS transistors D1, D2, and D3 are thin gate oxide MOSFETs, each having a thin gate insulating film of about several nm. In the first to third voltage dividing MOS transistors D1, D2, and D3, if a predetermined voltage is applied between the gates and the back gates, the gate insulating film leakage current flows out of the gate insulating film. The gate insulating film leakage current is very small (for example, about several nA), and the first to third voltage dividing MOS transistors D1, D2, and D3 function as resistance elements, each having a high resistance (for example, about several tens MΩ).

That is, resistance values of the first to third voltage dividing MOS transistors D1, D2, and D3 are greater than resistance values of the first to third resistance elements R1 to R3.

In addition, for example, the resistance ratios of the first to third voltage dividing MOS transistors D1, D2, and D3 are set so as to be equal to the resistance ratios of the first to third resistance elements R1 to R3.

In addition, as previously described, for example, the first to third voltage dividing MOS transistors D1, D2, and D3 are pMOS transistors in the example of FIG. 1.

In addition, element areas of the first to third voltage dividing MOS transistors D1, D2, and D3 are smaller than that of a polysilicon resistor with the same resistance value (area ratio becomes about 1/50).

In addition, as previously described, in the example in FIG. 1, each of the first to third voltage dividing MOS transistors D1, D2, and D3 is a pMOS transistor having the source, the drain, and the back gate that are connected in common to one end, and having the gate connected to the other end.

However, the first voltage dividing MOS transistor D1 may be an nMOS transistor having a source, a drain, and a back gate that are connected to the second node N2, and having a gate that is connected to the first node N1 (the output section 2a of the voltage control circuit 2), the second voltage dividing MOS transistor D2 may be an nMOS transistor having a source, a drain, and a back gate that are connected to the third node N3, and having a gate that is connected to the second node N2, and the third voltage dividing MOS transistor D3 may be an nMOS transistor having a source, a drain, and a back gate that are connected to the ground, and having a gate that is connected to the third node N3.

In addition, for example, in the second control MOS transistor M2, the first to third transmission gates G1 to G3, or the third operational amplifier OP3 that is previously described, a thick film MOSFET having a thicker gate insulating film than those of the first to third voltage dividing MOS transistors D1 to D3 is selected as a countermeasure with respect to the gate leakage current.

The output circuit 4 outputs the output voltage VOUT to an output terminal TOUT, based on a divided voltage that is obtained by dividing the voltage of the output section 2a using the first to third voltage dividing MOS transistors D1 to D3.

As illustrated in FIG. 1, the output circuit 4 includes an output operational amplifier OP3 and an output capacitor CO.

In addition, as illustrated in FIG. 1, the second operational amplifier OP2 has an inverting input terminal connected to the reference voltage terminal TV, and having a non-inverting input terminal connected to the first node N1.

The second operational amplifier OP2 controls a gate voltage of the second control MOS transistor M2, in such a manner that the reference voltage VREF is equal to the voltage of the first node N1.

The first transmission gate G1 has one end connected to the other end of the transmission gate GR, and has the other end connected to the first node N1.

The first transmission gate G1 turns on when the enable signal SE is a low level, and thereby the one end is electrically connected to the other end.

Meanwhile, the first transmission gate G1 turns off when the enable signal SE is a high level, and thereby the one end is electrically disconnected from the other end.

In addition, the second transmission gate G2 has one end connected to the other end of the first resistance element R1, and has the other end connected to the second node N2.

The second transmission gate G2 turns on when the enable signal SE is a low level, and thereby the one end is electrically connected to the other end.

Meanwhile, the second transmission gate G2 turns off when the enable signal SE is a high level, and thereby the one end is electrically disconnected from the other end.

The third transmission gate G3 has one end connected to the other end of the second resistance element R2, and has the other end connected to the third node N3.

The third transmission gate G3 turns on when the enable signal SE is a low level, and thereby the one end is electrically connected to the other end.

Meanwhile, the third transmission gate G3 turns off when the enable signal SE is a high level, and thereby the one end is electrically disconnected from the other end.

In addition, the first to third transmission gates G1 to G3, and the transmission gate GR are switching elements having a pMOS transistor and an nMOS transistor that are connected in parallel to each other.

In addition, the first capacitor C1 is connected between the first node N1 and the ground. The second capacitor C2 is connected between the second node N2 and the ground. The third capacitor C3 is connected between the third node N3 and the ground.

In addition, the output capacitor CO is connected between the output terminal TOUT and the ground.

As illustrated in FIG. 1, for example, the output operational amplifier OP3 has an inverting input terminal connected to an output, a non-inverting input terminal connected to the second node N2, and an output connected to the output terminal TOUT. The output operational amplifier OP3 outputs the output voltage VOUT to the output terminal TOUT, according to the voltage of the second node N2.

In addition, the output operational amplifier OP3 may have the non-inverting input terminal connected to, for example, the third node N3, instead of the second node N2. In this case, the output operational amplifier OP3 outputs the output voltage VOUT to the output terminal TOUT, according to the voltage of the third node N3.

That is, the voltage generating circuit 100 outputs the output voltage VOUT, based on a voltage that is obtained dividing the reference voltage VREF using the first to third voltage dividing MOS transistors D1 to D3.

Operation of the voltage generating circuit 100 having the configuration as described above is next described. Particularly, hereinafter, description is made with a focus on the operation characteristic of the voltage generating circuit 100, when the reference voltage VREF is changed.

For example, if the reference voltage VREF starts to increase, the second operational amplifier OP2 of the voltage generating circuit 100 controls the gate voltage of the second control MOS transistor M2, in such a manner that the reference voltage VREF is equal to the voltage of the first node N1.

However, as described above, the gate insulating film leakage currents of the first to third voltage dividing MOS transistors D1 to D3 in the voltage generating circuit 100 are significantly small. That is, currents that charge the first to third capacitors C1 to C3 are small.

For this reason, charging the capacitors, using only the gate insulating film leakage current, takes a long time from the time when the reference voltage VREF starts to increase to the time when the voltages of the first to third nodes N1 to N3 (the voltages divided by the first to third voltage dividing MOS transistors D1 to D3) to become stable.

In the voltage generating circuit 100, when the enable signal SE is a low level, the transmission gate GR turns on.

As a result, the other end (drain) of the first control MOS transistor M1 is electrically connected to the node NR.

Furthermore, in the voltage generating circuit 100, when the enable signal SE is a low level, the first operational amplifier OP1 operates.

As a result, the first operational amplifier OP1 controls the gate voltage of the first control MOS transistor M1, in such a manner that the reference voltage VREF is equal to the voltage of the node NR.

As described above, the first to third resistance elements R1 to R3 have small resistance values, and thus a large current flows. As a result, the voltage of the node NR relatively rapidly becomes equal to the reference voltage VREF.

The voltage of the other end of the first resistance element R1 becomes a voltage that is obtained by dividing the reference voltage VREF using a synthesized resistance of the first resistance element R1, the second resistance element R2, and the third resistance element R3. Furthermore, the voltage of the other end of the second resistance element R2 becomes a voltage that is obtained by dividing the reference voltage VREF using a synthesized resistance of the first resistance element R1 and the second resistance element R2, and the third resistance element R3.

Furthermore, as described above, in the voltage generating circuit 100, when the enable signal SE is a low level, the first to third transmission gates G1 to G3 turn on.

As a result, the node NR is electrically connected to the first node N1, the other end of the first resistance element R1 is electrically connected to the second node N2, and the other end of the second resistance element R2 is electrically connected to the third node N3. Thus, the current that charges the first to third capacitors C1 to C3 is increased.

That is, the voltages (the voltages divided by the first to third voltage dividing MOS transistors D1 to D3) of the first to third nodes N1 to N3 reach more rapidly the predetermined divided voltages (first to third target voltages), respectively.

In this way, by adding the current flowing through the first to third resistance elements R1 to R3 to a charged current, it is possible to reduce time from the time when the reference voltage VREF starts to increase to the time when the voltages of the first to third nodes N1 to N3 (voltages divided by the first to third voltage dividing MOS transistors D1 to D3) become stable.

Thereafter, in the voltage generating circuit 100, in a state where the enable signal SE is a low level, after a lapse of a specified period, when the enable signal SE becomes a high level, the first operational amplifier OP1 is disabled. Furthermore, the supply of the enable signal is stopped, and thereby the transmission gate GR, the first transmission gate G1, and the second transmission gate G2 turns off, and the current flowing through the first to third resistance elements R1 to R3 is blocked.

In addition, for example, the above-described specified period is a period from the time when the enable signal SE is supplied to the set terminal TS to the time when the voltage of the node NR reaches the reference voltage VREF (the voltage divided by the first to third voltage dividing MOS transistor D1 to D3 becomes stable, that is, the output voltage VOUT is stable).

As a result, after the output voltage VOUT is stable, it is possible to reduce the current consumption of the first operational amplifier OP1 and the first to third resistance elements R1 to R3.

Furthermore, after the output voltage VOUT is stable, the gate insulating film leakage current flows through the first to third voltage dividing MOS transistors D1 to D3, but the leakage current is very much smaller than the current flowing through the first to third resistance elements R1 to R3.

That is, it is possible to reduce the current consumption of the voltage generating circuit 100.

Here, for example, a practical upper limit of the resistance value in a range in which an element area of the polysilicon resistor is not excessively wide is about an order of several MQ to 10 MΩ. In this case, the current consumed by the voltage dividing circuit that uses 1 V power supply and a polysilicon resistor of 10 MΩ is equal to or greater than 0.1 uA.

As described above, after the power supply voltage and the reference voltage VREF are applied, the voltage generating circuit 100 supplies the target voltage that is rapidly generated by the auxiliary circuit 1 to the first to third nodes N1 to N3, in response to the enable signal SE, and then stops the auxiliary circuit 1. As a result, an operation that reduces the current consumption of the auxiliary circuit 1 is performed, making it possible to reduce the time when the divided voltage of the voltage dividing circuit 2 becomes stable. That is, it is possible to reduce a convergence time of the output current based on the divided voltage, in the voltage generating circuit 100.

Particularly, in the present embodiment, the thin gate oxide MOSFETs (the first to third voltage dividing MOS transistors D1 to D3) are used for the voltage dividing circuit 2, and thus, it is possible to reduce the current that is consumed by the voltage dividing circuit 2 to the order of several nA. Furthermore, the thin gate oxide MOSFET may obtain a large resistance value from a smaller circuit area than the polysilicon resistor, and thus it is possible to reduce the circuit area.

As described above, according to the voltage generating circuit of the first embodiment, it is possible to reduce a circuit area, to reduce current consumption, and to reduce a convergence time of the output voltage.

### Second Embodiment

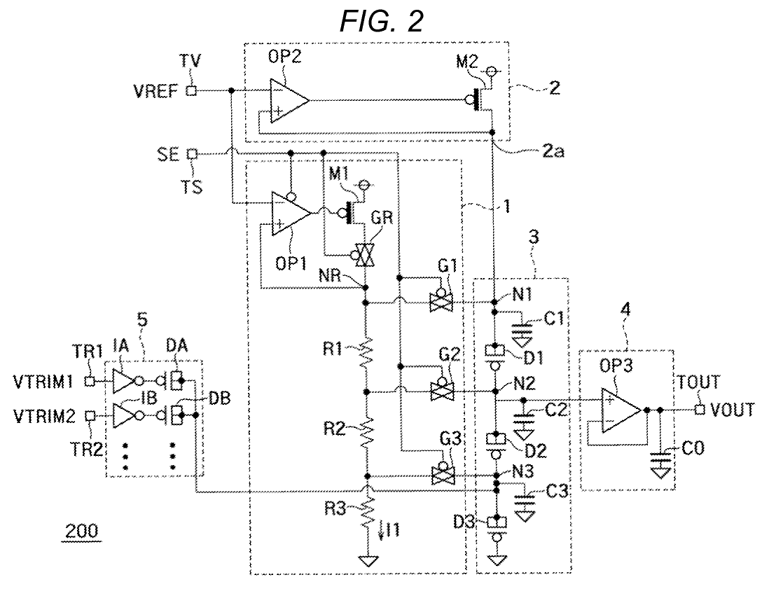

FIG. 2 is a diagram illustrating an example of a configuration of a voltage generating circuit 200 according to a second embodiment. In addition, in FIG. 2, the same symbols and reference numerals as those of FIG. 1 represent the same configurations as those of the first embodiment.

As illustrated in FIG. 2, the voltage generating circuit 200 includes trimming terminals TR1 and TR2, the reference voltage terminal TV, the set terminal TS, the output terminal TOUT, the auxiliary circuit 1, the voltage control circuit 2, the voltage dividing circuit 3, the output circuit 4, a trimming circuit 5.

That is, the voltage generating circuit 200 according to the second embodiment illustrated in FIG. 2 further includes the trimming terminals TR1 and TR2, and the trimming circuit 5, as compared to the voltage generating circuit 100 illustrated in FIG. 1.

The trimming circuit 5 performs trimming of the currents flowing in the second and third nodes N2 and N3.

As illustrated in FIG. 2, for example, the trimming circuit 5 includes inverters IA and IB, and trimming MOS transistors DA and DB.

Here, trimming signals VTRIM1 and VTRIM2 are supplied to the trimming terminals TR1 and TR2. In addition, the trimming signals VTRIM1 and VTRIM2 are signals having two values, either a high level or a low level.

In addition, inputs of the inverters IA and IB are connected to the trimming terminals TR1 and TR2. The voltages that are applied to the inverters IA and IB are, for example, a power supply voltage, a reference voltage, and the like.

In an example in FIG. 2, the trimming MOS transistors DA and DB are connected between the third node N3 and outputs of the inverters IA and IB.

In addition, the trimming MOS transistors DA and DB may be connected between the second node N2 and the outputs of the inverters IA and IB.

In the example in FIG. 2, the trimming MOS transistors DA and DB are pMOS transistors, each having a source, a drain, and a back gate that are connected to the third node N3, and having a gate connected to each of the outputs of the inverters IA and IB.

Alternatively, the trimming MOS transistors DA and DB are nMOS transistors, each having a source, a drain, and a back gate that are connected to each of the outputs of the inverters IA and IB, and having a gate connected to the third node N3.

Yet another alternative is that the trimming MOS transistors DA and DB are pMOS transistors, each having a source, a drain, and a back gate that are connected to the second node N2, and having a gate connected to each of the outputs of the inverters IA and IB.

Yet another alternative is that trimming MOS transistors DA and DB are nMOS transistors, each having a source, a drain, and a back gate that are connected to each of the outputs of the inverters IA and IB, and having a gate connected to the second node N2.

The other configurations of the voltage generating circuit 200 are the same as those of the voltage generating circuit 100 according to the first embodiment illustrated in FIG. 1.

Operation of the voltage generating circuit 200 having the above-described configuration is next described.

When the trimming signal VTRIM1 is a low level, the output of the inverter IA becomes a high level (for example, power supply voltage), and thus a current flows into the third node N3 via the trimming MOS transistor DA.

When the trimming signal VTRIM1 is a high level, the output of the inverter IA becomes a low level (ground), and thus a portion of the current flowing through the third voltage dividing MOS transistor D3 flows into the ground via the trimming MOS transistor DA.

The other trimming signal VTRIM2 performs the same operation as the trimming signal VTRIM1.

In this way, in the present embodiment, a portion of the current flowing from the second voltage dividing MOS transistor D2 to the third voltage dividing MOS transistor D3 is diverted as the gate insulating film leakage currents of the trimming MOS transistors DA and DB or the like. As a result, the voltages in the first to third nodes N1 to N3 are adjusted, making it possible to trim the output voltage VOUT.

The other configurations and operations of the voltage generating circuit 200 are the same as those of the voltage generating circuit 100 according to the first embodiment illustrated in FIG. 1.

That is, according to the voltage generating circuit according to the second embodiment, it is possible to reduce a circuit area, reduce current consumption, and reduce a convergence time of the output voltage.

### Third Embodiment

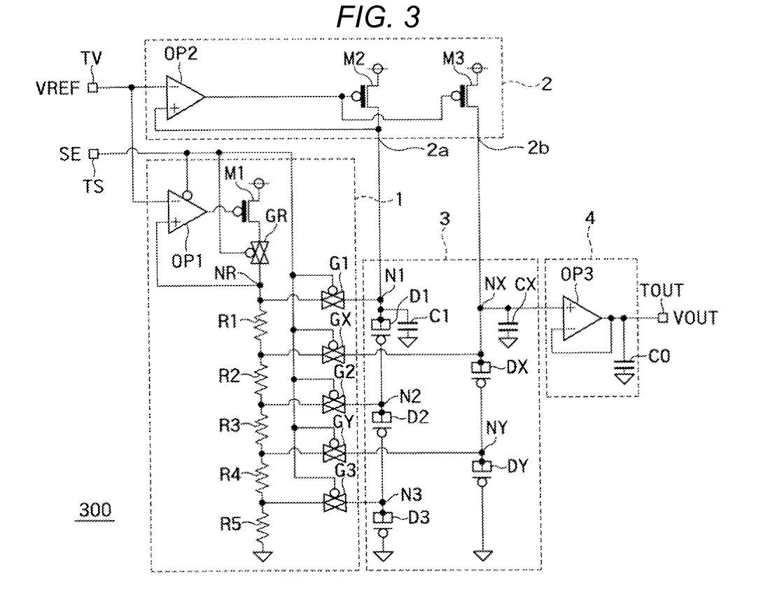

FIG. 3 is a diagram illustrating an example of a configuration of a voltage generating circuit 300 according to a third embodiment. In addition, in FIG. 3, the same symbols and reference numerals as those of FIG. 1 represent the same configurations as those of the first embodiment.

As illustrated in FIG. 3, the voltage generating circuit 300 includes the auxiliary circuit 1, the voltage control circuit 2, the voltage dividing circuit 3, the output circuit 4, the reference voltage terminal TV, the set terminal TS, and the output terminal TOUT.

In response to the enable signal SE, the auxiliary circuit 1 outputs a first target voltage to the first node N1, outputs a second target voltage to the second node N2, outputs a third target voltage to the third node N3, outputs the fourth target voltage to an output voltage generating node NX, and outputs the fifth target voltage to an output voltage generating node NY.

In addition, the first target voltage is set to a voltage that is equal to a voltage of the first node N1 when the output voltage VOUT is in a normal state. The second target voltage is set to a voltage that is equal to a voltage of the second node N2 when the output voltage VOUT is in a normal state. The third target voltage is set to a voltage that is equal to a voltage of the third node N3 when the output voltage VOUT is in a normal state. The fourth target voltage is set to a voltage that is equal to a voltage of the output voltage generating node NX when the output voltage VOUT is in a normal state. Lastly, the fifth target voltage is set to a voltage that is equal to a voltage of the output voltage generating node NY when the output voltage VOUT is in a normal state.

Here, as illustrated in FIG. 3, for example, the auxiliary circuit 1 includes the first to third resistance elements R1 to R3, a first control MOS transistor M1, the first to third transmission gates G1 to G3, the current supply blocking transmission gate GR, the first operational amplifier OP1, and output voltage generating transmission gates GX and GY. The auxiliary circuit 1 illustrated in FIG. 3 further includes fourth and fifth resistance elements R4 and R5, and the output voltage generating transmission gates GX and GY, as compared to the configuration illustrated in FIG. 1.

The first resistance element R1 has one end connected to the node NR.

The second resistance element R2 has one end connected to the other end of the first resistance element R1.

The third resistance element R3 has one end connected to the other end of the second resistance element R2, and has the other end connected to the ground (via the fourth and fifth resistance elements R4 and R5).

The fourth resistance element R4 has one end connected to the other end of the third resistance element R3.

The fifth resistance element R5 has one end connected to the other end of the fourth resistance element R4, and has the other end connected to the ground.

The first transmission gate G1 has one end connected to the other end of the transmission gate GR, and has the other end connected to the first node N1.

When the enable signal SE is a low level, the first transmission gate G1 turns on, and thereby the one end thereof is electrically connected to the other end thereof.

Meanwhile, when the enable signal SE is a high level, the first transmission gate G1 turns off, and thereby the one end thereof is electrically disconnected to the other end thereof.

In addition, the second transmission gate G2 has one end connected to the other end of the second resistance element R2, and has the other end connected to the second node N2.

When the enable signal SE is a low level, the second transmission gate G2 turns on, and thereby the one end thereof is electrically connected to the other end thereof.

Meanwhile, when the enable signal SE is a high level, the second transmission gate G2 turns off, and thereby the one end thereof is electrically disconnected from the other end thereof.

In addition, the third transmission gate G3 has one end connected to the other end of the fourth resistance element R4, and has the other end connected to the third node N3.

When the enable signal SE is a low level, the third transmission gate G3 turns on, and thereby the one end thereof is electrically connected to the other end thereof.

Meanwhile, when the enable signal SE is a high level, the third transmission gate G3 turns off, and thereby the one end thereof is electrically disconnected from the other end thereof.

The voltage control circuit 2 includes output portions 2a and 2b, and outputs voltages that are controlled so as to be equal to the voltage of the reference voltage terminal TV to the output portions 2a and 2b.

As illustrated in FIG. 3, for example, the voltage control circuit 2 includes second and third control MOS transistors M2 and M3, and the second operational amplifier OP2.

The third control MOS transistor M3 has one end (source) connected to the power supply, the other end (drain) that is the output section 2b and connected to the output voltage generating node NX, and a gate connected to the gate of the second control MOS transistor. The third control MOS transistor M3 has a conductivity type that is the same as the second control MOS transistor M2 (pMOS transistor, in FIG. 3).

Thus, when the second operational amplifier OP2 operates, a voltage of the other end (output voltage generating node NX) of the third control MOS transistor M3 is controlled so as to be equal to the reference voltage VREF.

The voltage dividing circuit 3 is connected between the output section 2b and the ground.

As illustrated in FIG. 3, for example, the voltage dividing circuit 3 includes first to third voltage dividing MOS transistors D1 to D3, the first capacitor C1, output voltage generating MOS transistor DX and DY, and a capacitor CX. In addition, the voltage dividing circuit 3 illustrated in FIG. 3 has no second and third capacitors C2 and C3, as compared to the configuration illustrated in FIG. 1.

The output voltage generating MOS transistors DX and DY are connected in series between the output voltage generating node NX (output section 2b) and the ground, in such a manner that gate insulating film leakage current flows.

As illustrated in FIG. 3, for example, the output voltage generating MOS transistor DX is a pMOS transistor having a source, a drain, and a back gate that are connected to the output voltage generating node NX, and having a gate connected to the output voltage generating node NY. In addition, the output voltage generating MOS transistor DY is a pMOS transistor having a source, a drain, and a back gate that are connected to the output voltage generating node NY, and having a gate connected to the ground.

In addition, the output voltage generating MOS transistor DX may be an nMOS transistor having a source, a drain, and a back gate that are connected to the output voltage generating node NY, and having a gate connected to the output voltage generating node NX. The output voltage generating MOS transistor DY may be an nMOS transistor having a source, a drain, and a back gate that are connected to the ground, and having a gate connected to the output voltage generating node NY.

The output voltage generating transmission gate GX has one end connected to the other end of the first resistance element R1, and the other end connected to the output voltage generating node NX. When the enable signal SE is a low level, the output voltage generating transmission gate GX turns on.

When the enable signal SE is a low level, the output voltage generating transmission gate GX turns on, and thereby the one end thereof is electrically connected to the other end thereof.

Meanwhile, when the enable signal SE is a high level, the output voltage generating transmission gate GX turns off, and thereby the one end thereof is electrically disconnected from the other end thereof.

The output voltage generating transmission gate GY has one end connected to the other end of the third resistance element R3, and having the other end connected to the output voltage generating node NY. When the enable signal SE is a low level, the output voltage generating transmission gate GY turns on.

When the enable signal SE is a low level, the output voltage generating transmission gate GY turns on, and thereby the one end thereof is electrically connected to the other end thereof.

Meanwhile, when the enable signal SE is a high level, the output voltage generating transmission gate GY turns off, and thereby the one end thereof is electrically disconnected to the other end thereof.

In addition, the capacitor CX is connected between the output voltage generating node NX and the ground.

In addition, the output circuit 4 outputs the output voltage VOUT to the output terminal TOUT, based on a voltage of the second output section 2b (output voltage generating node NX).

As illustrated in FIG. 3, for example, the output circuit 4 includes the output operational amplifier OP3, and the output capacitor CO.

As illustrated in FIG. 3, for example, the output operational amplifier OP3 has an inverting input terminal and an output terminal that are connected to each other, and has a non-inverting input terminal connected to the output voltage generating node NX. An output of the output operational amplifier OP3 is connected to the output terminal TOUT. The output operational amplifier OP3 outputs the output voltage VOUT to the output terminal TOUT, according to the voltage of the output voltage generating node NX.

In addition, the non-inverting input terminal of the output operational amplifier OP3 may be connected to the output voltage generating node NY, instead of the output voltage generating node NX. In this case, the output operational amplifier OP3 outputs the output voltage VOUT to the output terminal TOUT, according to the voltage of the output voltage generating node NY.

That is, the voltage generating circuit 300 outputs the output voltage VOUT, based on voltages of the output voltage generating node NX and NY.

If the number of the voltage dividing MOS transistors that are connected in series to each other is more than the reference voltage that is set in advance, the gate-source voltage Vgs of the MOS transistor decreases. When the gate-source voltage Vgs of the MOS transistor is small (less than 0.4 V), the known gate insulating film leakage current is not obtained with a sufficient magnitude, and the voltage division performed by the MOS transistor may not be made.

Therefore, in the present embodiment, the voltage is divided by the output voltage generating MOS transistors DX and DY that are provided separately from the first to third voltage dividing MOS transistors D1 to D3. As a result, it is possible to perform a voltage division in such a manner that a voltage difference is less than 0.4 V, by using the gate insulating film leakage current when Vgs 0.4 V, for example.

Particularly, it is possible to obtain a necessary voltage by adjusting a ratio of the current flowing through the second and third control MOS transistors M2 and M3, a size ratio of the MOS transistors, the number of serial stages of the MOS transistors, or the like.

The other configurations and operation characteristics of the voltage generating circuit 300 are the same as those of the voltage generating circuit 100 according to the first embodiment illustrated in FIG. 1.

That is, according to the voltage generating circuit of the third embodiment, it is possible to reduce a circuit area, reduce current consumption, and reduce a convergence time of the output voltage.

In addition, a configuration (trimming circuit) in which the gate insulating film leakage current according to the second embodiment diverts may be applied to the voltage generating circuit according to the third embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voltage generating circuit comprising:
a voltage control circuit that includes an output section and a reference voltage terminal to which a reference voltage is supplied, and outputs a voltage to the output section, the output voltage being controlled so as to be equal to a voltage of the reference voltage terminal;
at least two voltage dividing MOS transistors connected in series including a first voltage dividing MOS transistor having a first end connected to the output section and a second voltage dividing MOS transistor having a first end connected to a second end of the first voltage dividing MOS transistor;
an auxiliary circuit that includes a set terminal to which an enable signal is supplied, and in response to the enable signal, outputs a first target voltage to the first end of the first voltage dividing MOS transistor and outputs a second target voltage to the first end of the second voltage dividing MOS transistor; and
an output circuit including an output terminal and configured to output the output voltage to the output terminal, based on a voltage that is obtained by dividing the voltage of the output section using the first and second voltage dividing MOS transistors.

2. The voltage generating circuit according to claim 1, wherein
the first voltage dividing MOS transistor is a pMOS transistor having a source, a drain, and a back gate that are connected to the output section of the voltage control circuit and having a gate connected to the first end of the second voltage dividing MOS transistor.

3. The voltage generating circuit according to claim 2, wherein
the at least two voltage dividing MOS transistors connected in series further includes a third voltage dividing MOS transistor having a first end connected to a second end of the second voltage dividing MOS transistor and a second end connected to ground, and
the second voltage dividing MOS transistor is a pMOS transistor having a source, a drain, and a back gate that are connected to the second end of the first voltage dividing MOS transistor and having a gate connected to the first end of the third voltage dividing MOS transistor.

4. The voltage generating circuit according to claim 3, wherein the third voltage dividing MOS transistor is a pMOS transistor having a source, a drain, and a back gate that are connected to the second end of the second voltage dividing MOS transistor and having a gate connected to ground.

5. The voltage generating circuit according to claim 1, wherein
the first voltage dividing MOS transistor is an nMOS transistor having a source, a drain, and a back gate that are connected to the first end of the second voltage dividing MOS transistor and having a gate connected to the output section of the voltage control circuit.

6. The voltage generating circuit according to claim 5, wherein
the at least two voltage dividing MOS transistors connected in series further includes a third voltage dividing MOS transistor having a first end connected to a second end of the second voltage dividing MOS transistor and a second end connected to ground, and
the second voltage dividing MOS transistor is an nMOS transistor having a source, a drain, and a back gate that are connected to the first end of the third voltage dividing MOS transistor and having a gate connected to the second end of the first voltage dividing MOS transistor.

7. The voltage generating circuit according to claim 6, wherein the third voltage dividing MOS transistor is a nMOS transistor having a source, a drain, and a back gate that are connected to ground and having a gate connected to the second end of the second voltage dividing MOS transistor.

8. The circuit according to claim 1, wherein the voltage control circuit includes:
a second control MOS transistor having one end connected to the power supply; and
a second operational amplifier that controls a gate voltage of the second control MOS transistor in such a manner that the reference voltage is equal to a voltage of the other end of the second control MOS transistor; and
wherein the auxiliary circuit includes:
a first control MOS transistor having one end connected to a power supply;
a first switching element having one end connected to the other end of the first control MOS transistor;
a first resistance element having one end connected to the other end of the first switching element;
a second resistance element having one end connected to the other end of the first resistance element, and having the other end connected to the ground;
a first operational amplifier that operates in response to the enable signal, and controls a gate voltage of the first control MOS transistor in such a manner that the reference voltage is equal to a voltage of the other end of the first switching element;
a second switching element having one end connected to the other end of the first switching element and having the other end connected to the other end of the second control MOS transistor, and turning on in response to the enable signal; and
a third switching element having one end connected to the other end of the first resistance element and having the other end connected to the other end of the first voltage dividing MOS transistor, and turning on in response to the enable signal.

9. The circuit according to claim 8,
wherein, when the first operational amplifier operates, the first switching element, the second switching element, and the third switching element turn on, in response to the enable signal, and
wherein after a lapse of a specified period, when the first operational amplifier stops operation, and the first switching element, the second switching element, and the third switching element turn off.

10. The circuit according to claim 9,
wherein the specified period is a period from a time when the enable signal is supplied to the set terminal to a time when a voltage of the other end of the first switching element becomes the reference voltage.

11. A voltage generating circuit comprising:
a voltage control circuit configured to output a first predetermined voltage according to a reference voltage;
an auxiliary circuit configured to divide the reference voltage and output at least first and second target voltages in response to an enable signal;
a voltage dividing circuit configured to divide a voltage according to the first and second target voltages; and
an output circuit configured to output an output voltage, according to the divided voltage.

12. The circuit according to claim 11,
wherein the voltage dividing circuit is configured to generate a first leakage current using the first predetermined voltage.

13. The circuit according to claim 12, further comprising:
a trimming circuit capable of increasing or decreasing a current value of the first leakage current.

14. The circuit according to claim 12,
wherein the voltage control circuit is configured to further output a second predetermined voltage according to the reference voltage, and
wherein the voltage dividing circuit is configured to further generate a second leakage current using the second predetermined voltage.

15. The circuit according to claim 14,
wherein the voltage control circuit is configured to output the first and second predetermined voltages so as to be equal to the reference voltage, and
wherein the output circuit is configured to output the output voltage so as to be equal to the divided voltage.

16. A method of generating a voltage, comprising:
outputting a first predetermined voltage according to a reference voltage;
dividing the reference voltage and outputting at least first and second target voltages in response to an enable signal;
dividing a voltage according to the first and second target voltages; and
outputting an output voltage according to the divided voltage.

17. The method according to claim 16, further comprising:
generating a first leakage current using the first predetermined voltage.

18. The method according to claim 17, further comprising:
increasing or decreasing a current value of the first leakage current.

19. The method according to claim 17, further comprising:
outputting a second predetermined voltage according to the reference voltage, and
generating a second leakage current using the second predetermined voltage.

20. The method according to claim 19, further comprising:
outputting the first and second predetermined voltages so as to be equal to the reference voltage, and
outputting the output voltage so as to be equal to the divided voltage.
